(19) United States
(12) Patent Application Publication
(10) Pub. No.: US 2012/0294507 A1
(43) Pub. Date: Nov. 22, 2012

(54) DEFECT INSPECTION METHOD AND DEVICE THEREOF

(76) Inventors: Kaoru Sakai, Yokohama (JP); Shunji Maeda, Yokohama (JP)

(21) Appl. No.: 13/520,227

(22) PCT Filed: Feb. 4, 2011
(86) PCT No.: PCT/JP2011/052430

§ 371 Date: Jul. 18, 2012

(30) Foreign Application Priority Data
Feb. 8, 2010 (JP) 2010-025368

(51) Int. Cl. G06K 9/46; G06K 9/00

(52) U.S. Cl. 382/149

(57) ABSTRACT

Disclosed is a defect inspection device that can highly accurately distinguish between true defects and noise/nuisance defects by means of integrating inspection results from different lighting conditions or detection conditions. Further disclosed is a method thereof. The defect inspection device—which is provided with: a lighting optical system that illuminates an inspected object under predetermined optical conditions; and a detection optical system that detects scattered light from the inspected object under predetermined detection conditions, and acquires image data—is characterized by being provided with: a defect candidate detection arbitrary unit that detects defect candidates from a plurality of image data acquired by the aforementioned detection optical system under differing optical conditions or image data acquisition conditions; and a post-inspection processing unit that integrates information about defect candidates detected from said plurality of image data, and differentiates defects from noise.

### TECHNICAL FIELD

The present invention relates to an inspection for detecting a minute pattern defect, a foreign particle or the like from an image (detected image) acquired using light, a laser, an electron beam or the like and representing an object to be inspected. The invention more particularly relates to a defect inspection device and a defect inspection method which are suitable for inspecting a defect on a semiconductor wafer, a defect on a TFT, a defect on a photomask or the like.

### BACKGROUND ART

A method disclosed in Japanese Patent No. 2976550 (Patent Document 1) describes a conventional technique for comparing a detected image with a reference image to detect a defect. In this technique, many images of chips regularly formed on a semiconductor wafer are acquired; a cell comparison inspection is performed to compare repeating patterns located adjacent to each other with each other for a memory mat formed in a periodic pattern in each of the chips on the basis of the acquired images and to detect a mismatched part as a defect. Further a chip comparison inspection is performed (separately from the cell comparison inspection) to compare patterns that are included in chips located near each other and correspond to each other for a peripheral circuit formed in a non-periodic pattern and to detect a mismatched part as a defect.

In addition, there is a method described in Japanese Patent No. 3808320 (Patent Document 2). In this method, a cell comparison inspection and a chip comparison inspection are performed on a memory mat which is included in a chip is set in advance, and results of the comparison are integrated to detect a defect. In the conventional techniques, information on arrangements of the memory mats and the peripheral circuit is defined in advance or obtained in advance, and the comparison inspections are switched in accordance with the arrangement information.

### PRIOR ART DOCUMENTS

### Patent Documents

### Patent Document 1: Japanese Patent No. 2976550

### Patent Document 2: Japanese Patent No. 3808320

### SUMMARY OF THE INVENTION

### Problems to be Solved by the Invention

In a semiconductor wafer that is an object to be inspected, a minute difference in the thicknesses of patterns in chips may occur even the chips are located adjacent to each other due to a planarization process by CMP. In addition, a difference in brightness of images between the chips may locally occur. Further, a difference in brightness of the chips may be derived from a variance of the widths of patterns. The cell comparison inspection is performed on patterns (to be compared) separated by a small distance from each other with a higher sensitivity than the chip comparison inspection. As indicated by reference numeral 174 of FIG. 17, when memory mats 1741 to 1748 having different periodic patterns exist within a chip, in the conventional techniques, it is cumbersome to define or obtain, in advance, arrangement information that is used for the cell comparison inspection for the memory mats. In some cases, the peripheral circuit includes periodic patterns, and in the conventional techniques, it is difficult to perform the cell comparison inspection on the patterns, or it is difficult to set the cell comparison inspection even when the cell comparison inspection can be performed on the patterns.

An object of the present invention is to provide a defect inspection device and method, which enable the detection of a defect even from a non-memory mat with the highest sensitivity without the need of setting of arrangement information of a pattern within a complex chip and the need of entering information in advance by a user.

### Means for Solving the Problems

In order to accomplish the aforementioned object, according to the present invention, a defect inspection device that inspects a pattern formed on a sample includes: table means that holds the sample thereon and is capable of continuously moving in at least one direction; image acquiring means that images the sample held on the table means and acquires an image of the pattern formed on the sample; pattern arrangement information extracting means that extracts arrangement information of the pattern from the image of the pattern that has been acquired by the image acquiring means; reference image generating means that generates a reference image from the arrangement information of the pattern and the image of the pattern, the arrangement information being extracted by the pattern arrangement information extracting means, the image of the pattern being acquired by the image acquiring means; and defect candidate extracting means that compares the reference image generated by the reference image generating means with the image of the pattern that has been acquired by the image acquiring means thereby extracting a defect candidate of the pattern.

In order to accomplish the aforementioned object, according to the present invention, a defect inspection device that inspects patterns that have been repetitively formed on a sample and originally need to have the same shape includes: table means that holds the sample thereon and is capable of continuously moving in at least one direction; image acquiring means that images the sample held on the table means and sequentially acquires images of the patterns that have been repetitively formed on the sample and originally need to have the same shape; standard image generating means that generates a standard image from the images of the patterns that have been sequentially acquired by the image acquiring means that have been repetitively formed and originally need to have the same shape; pattern arrangement information extracting means that extracts, from the standard image generated by the standard image generating means, arrangement information of the patterns that originally need to have the same shape; reference image generating means that generates a reference image using the arrangement information of the patterns extracted by the pattern arrangement information extracting means, and an image of a pattern to be inspected among the images of the patterns sequentially acquired by the image acquiring means that originally need to have the same shape, or the standard image generated by the standard image generating means; and defect candidate extracting means that compares the reference image generated by the reference image generating means with the image of the pattern to be inspected among the images of the patterns sequentially acquired by the image acquiring means that originally need to have the same shape thereby extracting a defect candidate of the pattern to be inspected.

In order to accomplish the aforementioned object, according to the present invention, a defect inspection method for inspecting a pattern formed on a sample includes the steps of: imaging the sample while continuously moving the sample in a direction, and acquiring images of the patterns formed on the sample; extracting arrangement information of the pattern from the acquired images of the patterns; generating a reference image from an image to be inspected among the acquired images of the patterns using the extracted arrangement information of the pattern; and comparing the generated reference image with the image to be inspected thereby extracting a defect candidate of the pattern.

In order to accomplish the aforementioned object, according to the present invention, a defect inspection method for inspecting patterns that have been repetitively formed on a sample and originally need to have the same shape includes the steps of: imaging the sample while continuously moving the sample in a direction, and sequentially acquiring images of the patterns that have been repetitively formed on the sample and originally need to have the same shape; generating a standard image from a plurality of images of the patterns that have been sequentially acquired in the step of imaging, said patterns are repetitively formed on the sample and originally need to have the same shape; extracting, from the generated standard image, arrangement information of the patterns that originally need to have the same shape; generating a reference image using the extracted arrangement information of the patterns, and an image of a pattern to be inspected among the images of the patterns that have been sequentially acquired that originally need to have the same shape, or the generated standard image; and comparing the generated reference image with the image of the pattern to be inspected thereby extracting a defect candidate of the pattern to be inspected.

### Effects of the Invention

According to the present invention, the device includes the means for obtaining arrangement information of a pattern, and the means for generating a self-reference image from the arrangement information of the pattern, performing a comparison and detecting a defect. Thus, a comparison inspection to be performed on the same chip is achieved, and a defect is detected with a high sensitivity, without setting arrangement information of a pattern within the complex chip in advance. In addition, when a pattern that is included in a certain chip and is similar to a certain pattern included in the certain chip is not detected, a self-reference image is interpolated only for the certain pattern using a pattern that is included in a chip located near the certain chip and corresponds to the certain pattern. For a non-memory mat region, it is possible to minimize a region to be subjected to a defect determination through a chip comparison, suppress a difference between the brightness of chips, and detect a defect over the wide range with a high sensitivity.

### BRIEF DESCRIPTION OF THE DRAWINGS

FIG. 1 is a conceptual diagram of assistance for explaining an example of a defect inspection process that is performed by an image processing unit.

FIG. 2 is a block diagram illustrating a concept of a configuration of a defect inspection device.

FIG. 3A is a block diagram illustrating an outline configuration of the defect inspection device.

FIG. 3B is a block diagram illustrating an outline configuration of a self-reference image generator 8-22.

FIG. 4A is a diagram illustrating the state in which images of chips are divided in a direction in which a wafer moves and the divided images are distributed to a plurality of processors.

FIG. 4B is a diagram illustrating the state in which images of the chips are divided in a direction perpendicular to the direction in which the wafer moves and the divided images are distributed to the plurality of processors.

FIG. 4C is a diagram illustrating an outline configuration of the image processing unit when all divided images that correspond to each other and represent one or more chips are input to a single processor A and a defect candidate is detected using the images.

FIG. 5A is a plan view of a wafer, illustrating a relationship between an arrangement of chips mounted on the wafer and partial images that represent parts that are included in the chips and whose positions correspond to each other.

FIG. 5B is a flowchart of a defect candidate extraction process that is performed by the self-reference image generator 8-22.

FIG. 6A is a detailed flowchart of step S503 of extracting arrangement information of patterns.

FIG. 6B is a diagram illustrating images of chips and illustrating an example in which a similar pattern that is included in an image of a first chip is searched from the image of the first chip.

FIG. 7 is a detailed flowchart of step S504 of generating a self-reference image.

FIG. 8 is a detailed flowchart of step S505 of performing a defect determination.

FIG. 9A is a flowchart of a defect candidate detection process according to a second embodiment.

FIG. 9B is a flowchart of a standard image generation process according to the second embodiment.

FIG. 9C is a diagram illustrating an outline configuration of a defect candidate detector of a defect inspection device according to the second embodiment.

FIG. 10A is a plan view of patterns, illustrating the state in which arrangement information of the patterns is extracted from images acquired under different two inspection conditions.

FIG. 10B is a graph illustrating similarities evaluated on the basis of the images acquired under the different two inspection conditions.

FIG. 11 is a flowchart of a defect candidate detection process according to a third embodiment.

FIG. 12A is a diagram illustrating the flow of a process of performing a defect determination using arrangement information of patterns when a single defect exists in the third embodiment.

FIG. 12B is a diagram illustrating the flow of a process of performing a defect determination using arrangement information of patterns when two defects exist in the third embodiment.

FIG. 13 is a diagram illustrating the flow of a process of performing a defect determination using two pieces of arrangement information of patterns when two defects exist in the third embodiment.

FIG. 14 is a diagram illustrating an example of images displayed on a screen as the contents and results of a defect determination according to the first embodiment.

FIG. 15A is a front view of a process result display screen displayed on a user interface unit (GUI unit).

FIG. 15B is a front view of another example of the process result display screen displayed on the user interface unit (GUI unit).

FIG. 16 is a schematic diagram illustrating the flow of a general process of inspecting a defect of a semiconductor wafer.

FIG. 17 is a plan view of a semiconductor chip provided with a plurality of memory mats having different periodic patterns.

### MODE FOR CARRYING OUT THE INVENTION

Embodiments of a defect inspection device and method according to the present invention are described with reference to the accompanying drawings. First, an embodiment of the defect inspection device, which performs dark-field illumination on a semiconductor wafer that is an object to be inspected, is described below.

### First Embodiment

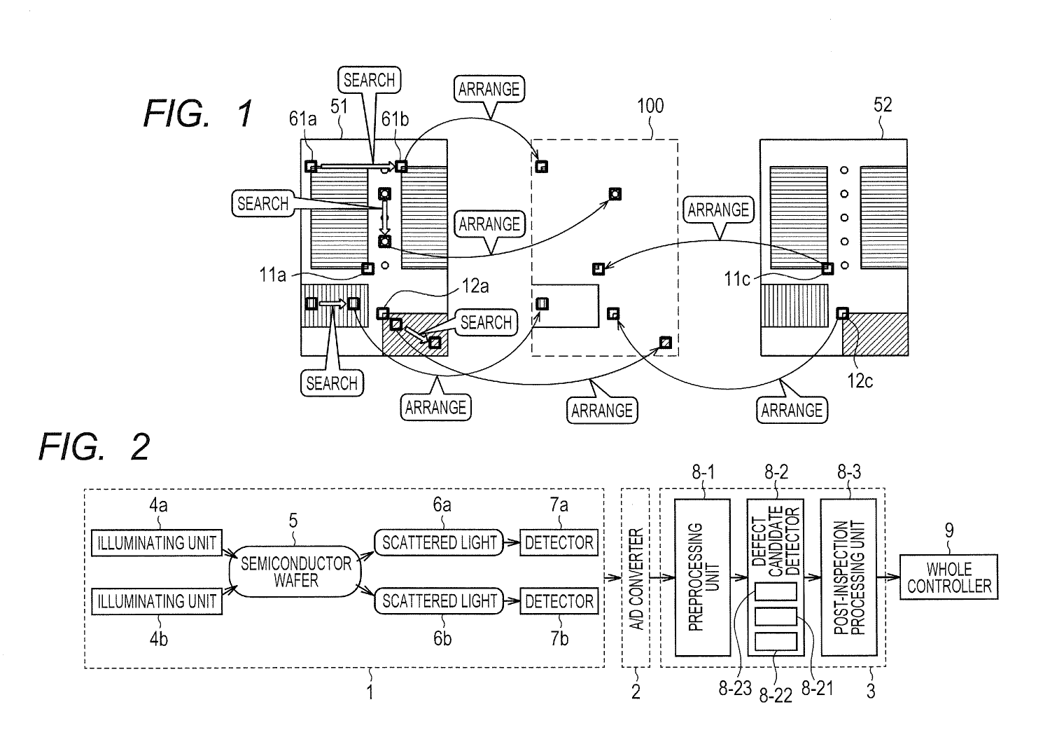

FIG. 2 is a conceptual diagram of assistance for explaining the embodiment of the defect inspection device according to the present invention. An optical system 1 includes a plurality of illuminating units 4a and 4b and a plurality of detectors 7a and 7b. An object to be inspected 5 (semiconductor wafer 5) to be inspected is irradiated by the illuminating units 4a and 4b with light, while at least one of illumination conditions (for example, an irradiation angle, an illumination direction, a wavelength, and a polarization state) of the illuminating unit 4a is different from a corresponding one of illumination conditions (for example, an irradiation angle, an illumination direction, a wavelength, and a polarization state) of the illuminating unit 4b. Light 6a is scattered from the object to be inspected 5 due to the light emitted by the illuminating unit 4a, while light 6b is scattered from the object to be inspected 5 due to the light emitted by the illuminating unit 4b. The scattered light 6a is detected by the detector 7a as a scattered light intensity signal, while the scattered light 6b is detected by the detector 7b as a scattered light intensity signal. The detected scattered light intensity signals are amplified and converted into digital signals by the A/D converter 2. Then, the digital signals are input to an image processing unit 3.

The image processing unit 3 includes a preprocessing unit 8-1, a defect candidate detector 8-2 and a post-inspection processing unit 8-3. The preprocessing unit 8-1 performs a signal correction, an image division and the like (described later) on the scattered light intensity signals input to the image processing unit 3. The defect candidate detector 8-2 includes a learning unit 8-21, a self-reference image generator 8-22 and a defect determining unit 8-23. The defect candidate detector 8-2 performs a process (described later) on an image generated by the preprocessing unit 8-1 and detects a defect candidate. The post-inspection processing unit 8-3 excludes noise and a nuisance defect (defect of a type unnecessary for a user or non-fatal defect) from the defect candidate detected by the defect candidate detector 8-2, classifies a remaining defect on the basis of the type of the remaining defect, estimates a dimension of the remaining defect, and outputs information including the classification and the estimated dimension to a whole controller 9.

FIG. 2 illustrates the embodiment in which the scattered light 6a and 6b is detected by the detectors 7a and 7b. The scattered light 6a and 6b may be detected by a single detector. The number of illuminating units and the number of detectors are not limited to two, and may be one, or three or more.

The scattered light 6a and 6b exhibit scattered light distributions corresponding to the illuminating unit 4a and 4b. When optical conditions for the light emitted by the illuminating unit 4a are different from optical conditions for the light emitted by the illuminating unit 4b, the scattered light 6a is different from the scattered light 6b. In the present embodiment, optical characteristics and features of the light scattered due to the emitted light are called scattered light distributions of the scattered light. Specifically, the scattered light distributions indicate distributions of optical parameter values such as an intensity, an amplitude, a phase, a polarization, a wavelength and coherency of the scattered light for a location at which the light is scattered, a direction in which the light is scattered, and an angle at which the light is scattered.

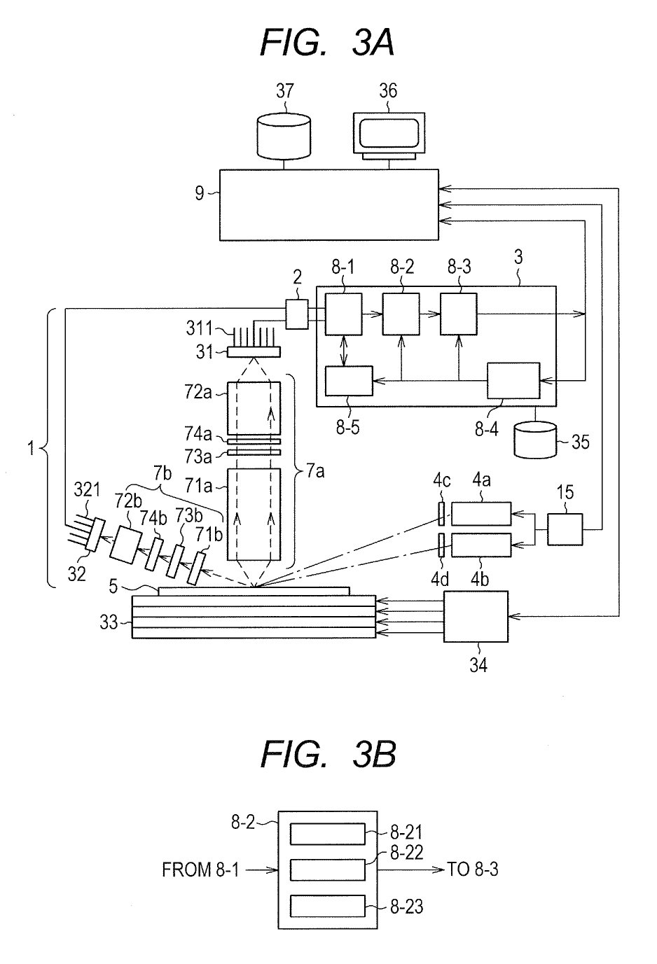

FIG. 3A is a block diagram illustrating the embodiment of the defect inspection device that achieves the configuration illustrated in FIG. 2. The defect inspection device according to the embodiment includes the plurality of illuminating units 4a and 4b, the detection optical system (upward detection system) 7a, the detection optical system (oblique detection system) 7b, the optical system 1, the A/D converter 2, the image processing unit 3 and the whole controller 9. The object to be inspected 5 (semiconductor wafer 5) is irradiated from oblique directions by the plurality of illuminating units 4a and 4b with the light. The detection optical system 7a images the light scattered from the object to be inspected 5 (semiconductor wafer 5) in a vertical direction. The detection optical system 7b images the light scattered from the object to be inspected 5 (semiconductor wafer 5) in an oblique direction. The optical system 1 has sensors 31 and 32 that receive optical images acquired by the detection optical systems and convert the images into image signals. The A/D converter 2 amplifies the received image signals and converts the image signals into digital signals.

The object to be inspected 5 (semiconductor wafer 5) is placed on a stage (X-Y-Z-θ stage) that is capable of moving and rotating in an XY plane and moving in a Z direction that is perpendicular to the XY plane. The X-Y-Z-θ stage 33 is driven by a mechanical controller 34. In this case, the object to be inspected 5 (semiconductor wafer 5) is placed on the X-Y-Z-θ stage 33. Then, light scattered from a foreign material existing on the object to be inspected 5 (the semiconductor wafer 5) is detected, while the X-Y-Z-θ stage 33 is moving in a horizontal direction. Results of the detection are acquired as two-dimensional images.

Light sources of the illuminating units 4a and 4b may be lasers or lamps. Wavelengths of the light to be emitted by the light sources may be short wavelengths or wavelengths of broadband light (white light). When light with a short wavelength is used, ultraviolet light with a wavelength (160 to 400 nm) may be used in order to increase a resolution of an image to be detected (or in order to detect a minute defect). When short wavelength lasers are used as the light sources, means 4c and 4d for reducing coherency may be included in the illuminating units 4a and 4b, respectively. The means 4c and 4d for reducing the coherency may be made up of rotary diffusers. In addition, the means 4c and 4d for reducing the coherency may be configured by using a plurality of optical fibers (with optical paths whose lengths are different), quartz plates or glass plates, and generating and overlapping a plurality of light fluxes that propagate in the optical paths whose lengths are different. The illumination conditions (the irradiation angles, the illumination directions, the wavelengths of the light, and the polarization state and the like) are selected by the user or automatically selected. An illumination driver 15 performs setting and control on the basis of the selected conditions.

Of the light scattered in the direction perpendicular to the semiconductor wafer 5 among the light scattered from the semiconductor wafer 5 is converted into an image signal by the sensor 31 through the detection optical system 7a. The light that is scattered in the direction oblique to the semiconductor wafer 5 is converted into an image signal by the sensor 32 through the detection optical system 7b. The detection optical systems 7a and 7b include objective lenses 71a and 71b and imaging lenses 72a and 72b, respectively. The lights are focused on and imaged by the sensors 31 and 32 respectively. Each of the detection optical systems 7a and 7b forms a Fourier transform optical system and can perform an optical process (such as a process of changing and adjusting optical characteristics by means of spatial filtering) on the light scattered from the semiconductor wafer 5. When the spatial filtering is to be performed as the optical process, and parallel light is used as the illumination light, the performance of detecting a foreign material is improved. Thus, split beams that are parallel light in a longitudinal direction are used for the spatial filtering.

Time delay integration (TDI) image sensors that are each formed by two-dimensionally arraying a plurality of one-dimensional image sensors in an image sensor are used as the sensors 31 and 32. A Signal that is detected by each of the one-dimensional image sensors is transmitted to a one-dimensional image sensor located at the next stage of the one-dimensional image sensor in synchronization with the movement of the X-Y-Z-θ stage 33 so that the one-dimensional image sensor adds the received signal to the signal detected by the one-dimensional image sensor. Thus, a two-dimensional image can be acquired at a relatively high speed and with a high sensitivity. When sensors of a parallel output type, which each include a plurality of output taps, are used as the TDI image sensors, each of the outputs 311 and 321 from the sensors 31 and 32 respectively can be processed in parallel so that detection is performed at a higher speed. Spatial filters 73a and 73b block specific Fourier components and suppress light diffracted and scattered from a pattern. Reference numerals 74a and 74b indicate optical filter means. The optical filter means 74a and 74b are each made up of an optical element (such as an ND filter or an attenuator) capable of adjusting the intensity of light, a polarization optical element (such as a polarization plate, a polarization beam splitter or a wavelength plate), a wavelength filter (such as a band pass filter or a dichroic mirror) or a combination thereof. The optical filter means 74a and 74b each control the intensity of detected light, a polarization characteristic of the detected light, a wavelength characteristic of the detected light, or a combination thereof.

The image processing unit 3 extracts information of a defect existing on the semiconductor wafer 5 that is the object to be inspected. The image processing unit 3 includes the preprocessing unit 8-1, the defect candidate detector 8-2, the post-inspection processing unit 8-3, a parameter setting unit 8-4 and a storage unit 8-5. The preprocessing unit 8-1 performs a shading correction, a dark level correction and the like on image signals received from the sensors 31 and 32 and divides the image signals into images of a certain size. The defect candidate detector 8-2 detects a defect candidate from the corrected and divided images. The post-inspection processing unit 8-3 excludes a nuisance defect and noise from the detected defect candidate, classifies a remaining defect on the basis of the type of the remaining defect, and estimates a dimension of the remaining defect. The parameter setting unit 8-4 receives parameters and the like from an external device and sets the parameters and the like in the defect candidate detector 8-2 and the post-inspection processing unit 8-3. The storage unit 8-5 stores data that is being processed and has been processed by the preprocessing unit 8-1, the defect candidate detector 8-2 and the post-inspection processing unit 8-3. The parameter setting unit 8-4 of the image processing unit 3 is connected to a database 35, for example.

The defect candidate detector 8-2 includes the learning unit 8-21, the self-reference image generator 8-22 and the defect determining unit 8-23, as illustrated in FIG. 3B.

The whole controller 9 includes a CPU (included in the whole controller 9) that performs various types of control. The whole controller 9 is connected to a user interface unit (GUI unit) 36 and a storage device 37. The user interface unit (GUI unit) 36 receives parameters and the like entered by the user and includes input means and display means for displaying an image of the detected defect candidate, an image of a finally extracted defect and the like. The storage device 37 stores a characteristic amount or an image of the defect candidate detected by the image processing unit 3. The mechanical controller 34 drives the X-Y-Z-θ stage 33 on the basis of a control command issued from the whole controller 9. The image processing unit 3, the detection optical systems 7a and 7b and the like are driven in accordance with commands issued from the whole controller 9.

The semiconductor wafer 5 that is the object to be inspected has many chips regularly arranged. Each of the chips has a memory mat part and a peripheral circuit part which are identical in shape in each chips. The whole controller 9 moves the X-Y-Z-θ stage 33 and thereby continuously moves the semiconductor wafer 5. The sensors 31 and 32 sequentially acquire images of the chips in synchronization with the movement of the X-Y-Z-θ stage 33. A standard image that does not include a defect is automatically generated for each of acquired images of the two types of the scattered light (6a and 6b). The generated standard image is compared with the sequentially acquired images of the chips, and whereby a defect is extracted.

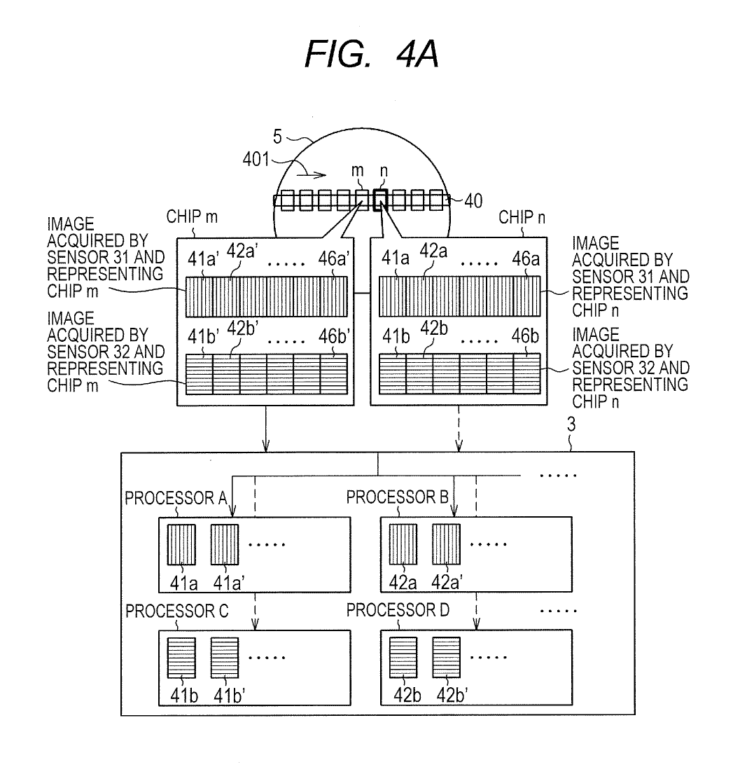

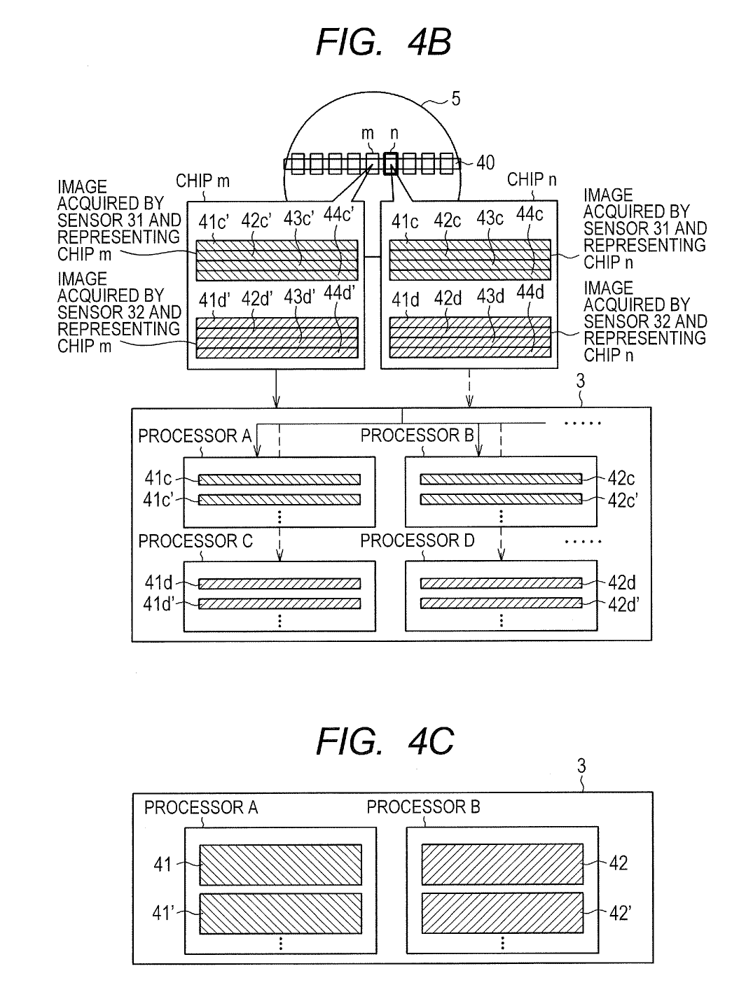

The flow of the data is illustrated in FIG. 4A. It is assumed that images of a belt-like region 40 that is located on the semiconductor wafer 5 and extends in a direction indicated by an arrow 401 are acquired while the X-Y-Z-θ stage 33 moves. When a chip n is a chip to be inspected, reference symbols 41a, 42a, . . . , 46a indicate six images (images acquired for six time periods into which a time period for which the chip n is imaged is divided) that are obtained by dividing an image (acquired by the sensor 31 and representing the chip n) in a direction in which the X-Y-Z-θ stage 33 moves. In addition, reference symbols 41a′, 42a′, . . . , 46a′ indicate six images acquired for six time periods into which a time period for which a chip m that is located adjacent to the chip n is imaged is divided, in the same manner as the chip n. The divided images that are acquired by the sensor 31 are illustrated using vertical stripes. Reference symbols 41b, 42b, . . . , 46b indicate six images (images acquired for six time periods into which a time period for which the chip n is imaged is divided) that are obtained by dividing an image (acquired by the sensor 32 and representing the chip n) in the direction in which the X-Y-Z-θ stage 33 moves. In addition, reference symbols 41b′, 42b′, . . . , 46b′ indicate six images (images acquired for six time periods into which a time period for which the chip m is imaged is divided) that are obtained by dividing an image (acquired by the sensor 32 and representing the chip m) in the direction (direction indicated by reference numeral 401). The divided images that are acquired by the sensor 32 are illustrated using horizontal stripes.

In the present embodiment, the images that are acquired by the two different detection systems (7a and 7b illustrated in FIG. 3A) and input to the image processing unit 3 are divided so that positions at which the images of the chip n are divided correspond to positions at which the images of the chip m are divided. The image processing unit 3 includes a plurality of processors that operate in parallel. Images (for example, the divided images 41a and 41a′ that are acquired by the sensor 31 and represent parts that are included in the chips n and m and whose positions correspond to each other, the divided images 41b and 41b′ that are acquired by the sensor 32 and represent parts that are included in the chips n and m and whose positions correspond to each other) that correspond to each other are input to the respective processors. The processors detect defect candidates in parallel from the divided images that have been acquired by the same sensor and represent parts that are included in the chips and whose positions correspond to each other.

Accordingly, when images of the same region that are acquired under different combinations of optical conditions and detection conditions are simultaneously input from the two sensors, a plurality of processors detect defect candidates in parallel (for example, processors A and C illustrated in FIG. 4A detect defect candidates in parallel, processors B and D illustrated in FIG. 4A detect defect candidates in parallel, and the like).

The candidates for the defect may be detected in chronological order from the images acquired under the different combinations of the optical conditions and the detection conditions. For example, after the processor A detects a defect candidate from the divided images 41a and 41a′, the processor A detects a defect candidate from the divided images 41b and 41b′. Alternatively, the processor A integrates the divided images 41a, 41a′, 41b and 41b′ acquired under different combinations of the optical conditions and the detection conditions and detects a defect candidate. It is possible to freely set a divided image among the divided images in each of the processers, and to freely set a divided image that is among the divided images and to be used to detect a defect.

The acquired images of the chips can be divided in a different direction, and a defect can be determined using the divided images. The flow of the data is illustrated in FIG. 4B. Reference symbols 41c, 42c, 43c and 44c indicate four images obtained by dividing an image (acquired by the sensor 31 and representing the chip n located in the belt-like region 40) in a direction (width direction of the sensor 31) perpendicular to a direction in which the stage moves. In addition, reference symbols 41c′, 42c′, 43c′ and 44c′ indicate four images obtained by dividing an image of the chip m located adjacent to the chip n in the same manner. These images are illustrated using downward-sloping diagonal lines. Images (41d to 44d and 41d′ to 44d′) acquired by the sensor 32 and divided in the same manner are illustrated in upward-sloping diagonal lines. Then, divided images that represent parts whose positions correspond to each other are input to each of the processors, and the processors detect defect candidates in parallel. The images of the chips may not be divided and may be input to the image processing unit 3 and processed by the image processing unit 3.

Reference symbols 41c to 44c illustrated in FIG. 4B indicate the images that represent the chip n and are included in an image that is acquired by the sensor 31 and represents the belt-like region 40. Reference symbols 41c′ to 44c′ indicate the images that represent the chip m located adjacent to the chip n and are included in the image that is acquired by the sensor 31 and represents the belt-like region 40. Reference numerals 41d to 44d indicate the images that represent the chip n and are included in an image that is acquired by the sensor 32. Reference numerals 41d′ to 44d′ indicate the images that represent the chip m and are included in the image that is acquired by the sensor 32. Images, which represent parts that are included in the chips and whose positions correspond to each other, are not divided on the basis of time periods for detection, unlike the method explained with reference to FIG. 4A, and may be input to the respective processors, and the processors may detect defect candidates.

FIGS. 4A and 4B illustrate the examples in which divided images of parts that are included in the chips n and m (located adjacent to each other) and whose positions correspond to each other are input to each of the processors and a defect candidate is detected by each of the processors. As illustrated in FIG. 4C, divided images of parts that are included in one or more chips (up to all the chips formed on the semiconductor wafer 5) and whose positions correspond to each other may be input to the processor A, and the processor A may use all the inputted divided images to detect a defect candidate. In any case, images (may be divided or not be divided) that are acquired under a plurality of optical conditions and represent parts that are included in the chips and whose positions correspond to each other are input to the same processor or each of the processors, and a defect candidate is detected for each of the images acquired under the optical conditions or is detected by integrating the images acquired under the optical conditions.

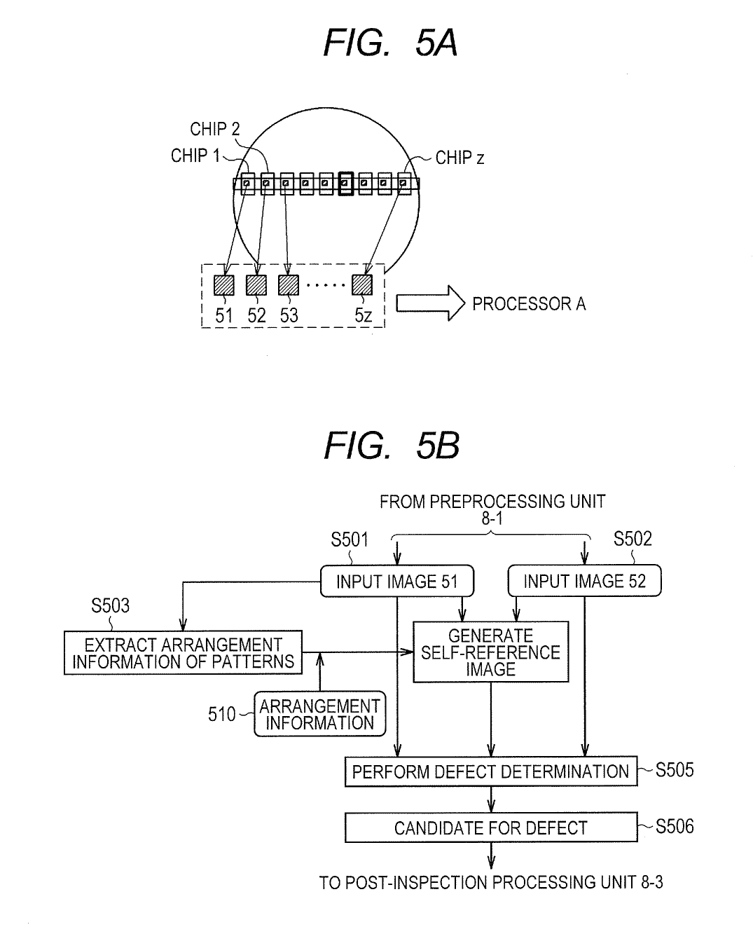

Next, the flow of a process to be performed by the defect candidate detector 8-2 of the image processing unit 3 is described. The process is performed by each of the processors. FIG. 5A illustrates relationships between a chip 1, a chip 2, a chip 3, . . . , and a chip z and divided images 51, 52, . . . , and 5z that are included in the image (acquired by the sensor 31 in synchronization with the movement of the stage 33 and illustrated in FIGS. 4A and 4B) representing the belt-like region 40 of the semiconductor wafer 5 and represent regions corresponding to the chips. FIG. 5B illustrates an outline of the flow of a process of inputting the divided images 51, 52, . . . , and 5z to the processor A and detecting a defect candidate from the divided images 51, 52, . . . , and 5z.

As illustrated in FIGS. 2 and 3, the defect candidate detector 8-2 includes the learning unit 8-21, the self-reference image generator 8-22 and the defect determining unit 8-23. When the image 51 of the first chip 1 is first input to the defect candidate detector 8-2 (S501), arrangement information of patterns is extracted from the input image 51 by the learning unit 8-21 (S503). In step S503, the patterns that are similar to each other and among patterns represented in the image 51 are searched and extracted from the image 51, and the positions of the extracted similar patterns are stored.

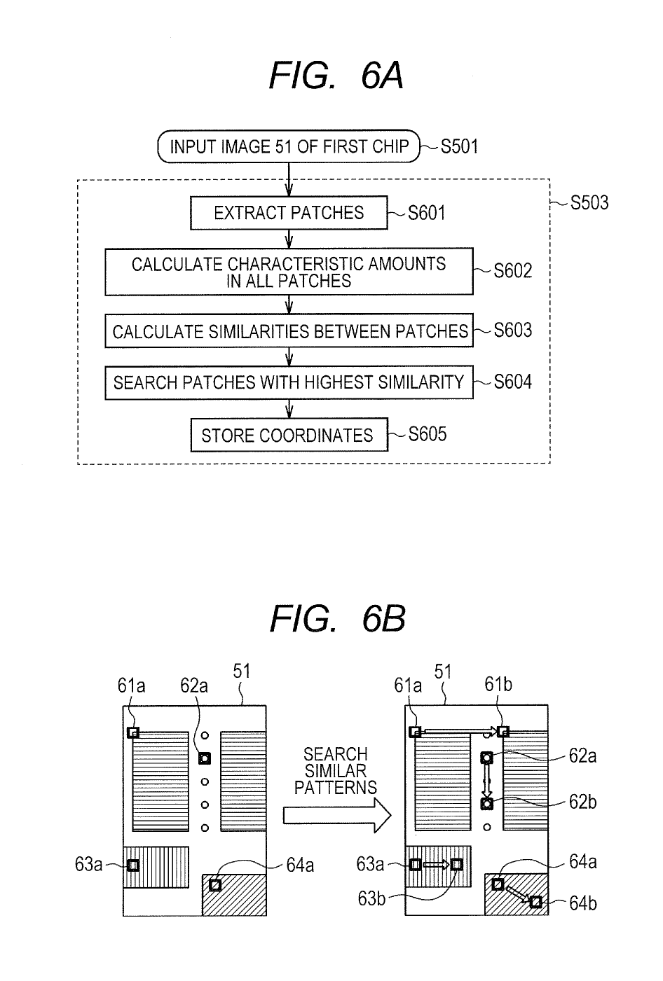

Details of step S503 of extracting the arrangement information of the patterns from the image 51 (of the first chip) input in step S501 are described with reference to FIG. 6A.

Small regions that each have N×N pixels and each include a pattern are extracted from the image 51 (of the first chip) input in step S501 (S601). Hereinafter, the small regions that each has N×N pixels are called patches. Next, one or more characteristic amounts of each of all the patches are calculated (S602). It is sufficient if one or more characteristic amounts of each of the patches represent a characteristic of the patch. Examples of the characteristic amounts are (a) a distribution of luminance values (Formula 1); (b) a distribution of contrast (Formula 2); (c) a luminance dispersion value (Formula 3); and (d) a distribution that represents an increase and reduction in luminance, compared with a neighborhood pixel (Formula 4).

When the brightness of each pixel (x, y) located in a patch is represented by f(x, y), the aforementioned characteristic amounts are represented by the following formulas.

[Formula 1]

The distribution of the luminance values; f(x+i, y+j) (Formula 1)

[Formula 2]

The contrast; c(x+i, y+j)

max{f(x+i, y+j), f(x+i+1, y+j), f(x+i, y+j +1), f(x+i+1, y+j+1)}

−min{f(x+i, y), f(x+i+1, y+j), f(x+i, y+j+1), f(x+i+1, y+j+1)} (Formula 2)

[Formula 3]

The luminance dispersion; g(x+i, y+j)

[Σ{f(x+i, y+j)²}−{Σf(x+i, y+j)}²/(N×N)]/(N×N−1) (Formula 3)

[Formula 4]

The distribution representing the increase and reduction in the luminance (x direction); g(x+i, y+j)

If {f(x+i, y+j)·f(x+i+1, y+j)>0}

then g(x+i, y+j)=1

else g(x+i, y+j)=0 (Formula 4)

In Formulas 1 to 4,

i, j=0, 1, . . . , N−1

Then, all or some of the characteristic amounts of each of the patches of the image 51 are selected, and similarities between the selected patches are calculated (S603). An example of the similarities is a distance between the patches on a characteristic space that has characteristics (indicated by Formulas 1 to 4) of N×N dimensions as axes. For example, when the distribution (a) of the luminance values is used as a characteristic amount, a similarity between a patch P1 (central coordinates (x, y)) and a patch P2 (central coordinates (x′, y′) is represented by the following.

$$\begin{matrix} [ Formula 5 ] & \\ Similarity = {\sum }_{i = - \frac{n - 1}{2}}^{\frac{n - 1}{2}} {\sum }_{j = - \frac{n - 1}{2}}^{\frac{n - 1}{2}} ( \vert f ( x + i , y + j ) - ( f ( {x}^{′} + i , {y}^{′} + j ) \vert ) / {N}^{2} & ( Formula 5 )\end{matrix}$$

A patch that has the highest similarity with each of the patches is searched (S604), and coordinate of the searched patch is stored as similar pattern in the storage unit 8-5 (S605).

For example, when a pattern that is similar to the patch P1 is the patch P2, similar pattern coordinate information of the patch P1 indicates the coordinates (x′, y′) of the patch P2. Similar pattern coordinate information is arrangement information of patterns that indicates the position of a similar pattern to be referenced for each of patterns included in the image or indicates that when similar pattern coordinate information that corresponds to coordinates (x, y) does not exist, a similar pattern does not exist. For example, as illustrated in FIG. 6B, results of searching patterns similar to patches 61a, 62a, 63a and 64a from the image 51 illustrated on the left side of FIG. 6B are patches 61b, 62b, 63b and 64b illustrated on the right side of FIG. 6B.

In the example illustrated in FIG. 5B, in step S504 of generating a self-reference image, which is a reference image that is used as the standard image for extraction of a defect candidate from the image 51 is generated on the basis of the pattern arrangement information extracted in step S503 using the image 51 that has been input in step S501 and represents the first chip. Hereinafter, a reference image that does not actually exist and is generated from an image to be inspected is called a self-reference image.

FIG. 1 illustrates a specific example of a method for generating a self-reference image. The method for generating a self-reference image is performed by the self-reference image generator 8-22 in step S504 of generating a self-reference image. In step S503, the learning unit 8-21 extracts pattern arrangement information from the image 51 to be inspected and searches similar patterns. When arrangement information 510 that indicates that patterns that are similar to the patches 61a, 62a, 63a and 64a are the patches 61b, 62b, 63b and 64b as illustrated in FIG. 6B is obtained as a result of the search, a self-reference image 100 is generated by arranging the patch 61b (specifically, luminance values of N×N pixels located in the patch 61b) at a position corresponding to the position of the patch 61a and arranging the patches 62b, 63b and 64b at positions corresponding to the positions of the patches 62a, 63a and 64a. In this case, when patches that are similar to each other do not exist in the image 51 like patches 11a and 12a, patches 11c and 12c (specifically, partial images of N×N pixels in the image 52) that are included in the divided image 52 located adjacent to the image 51 and whose positions correspond to the patches 11a and 12a are arranged and interpolated in the self-reference image 100.

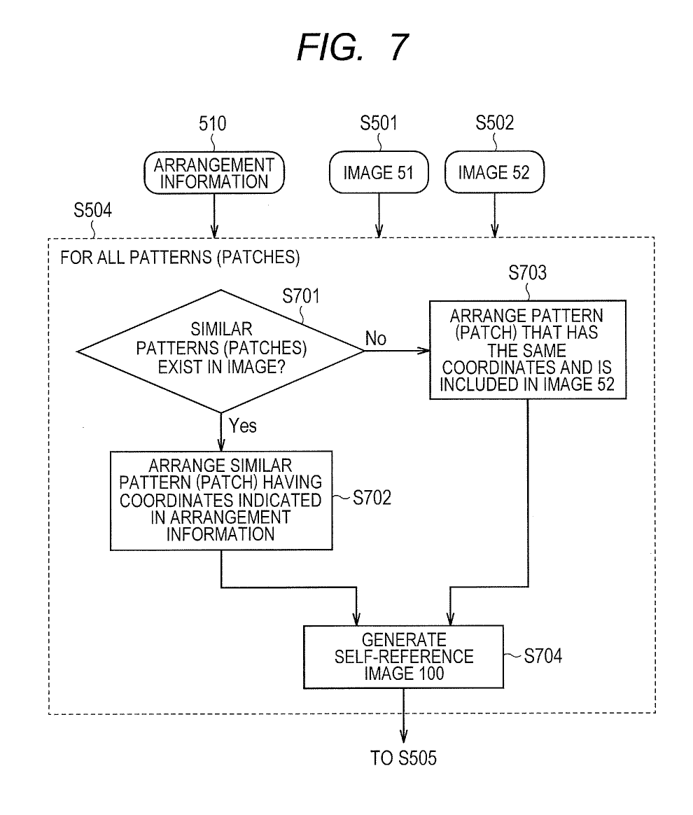

Details of step S504 of generating a self-reference image by means of the self-reference image generator 8-22 are described with reference to FIG. 7. First, the self-reference image generator 8-22 determines, on the basis of the pattern arrangement information 510 of a pattern extracted from the image (interested image) 51 of the first chip in step S501, whether or not similar patterns (patches) that are similar to each other exist in the image 51 (S701). When a pattern (patch) that is similar to the extracted pattern exists in the interested image 51, the similar pattern that has coordinates included in the arrangement information is arranged in the self-reference image 100 (S702). When a pattern (patch) that is similar to the extracted pattern does not exist in the interested image 51, a pattern that is included in the image 52 of the other region (adjacent chip 2) and has the same coordinates with the first chip is arranged in the self-reference image 100 (S703). Then, the self-reference image 100 is generated (S704).

The generated self-reference image 100 is transmitted to the defect determining unit 8-23, and step S505 of determining a defect is performed. The arrangement information 510 includes information that indicates whether or not a pattern that is similar to the extracted pattern is included in the interested image in each of the patches. The size N of each of the patches may be one or more pixels.

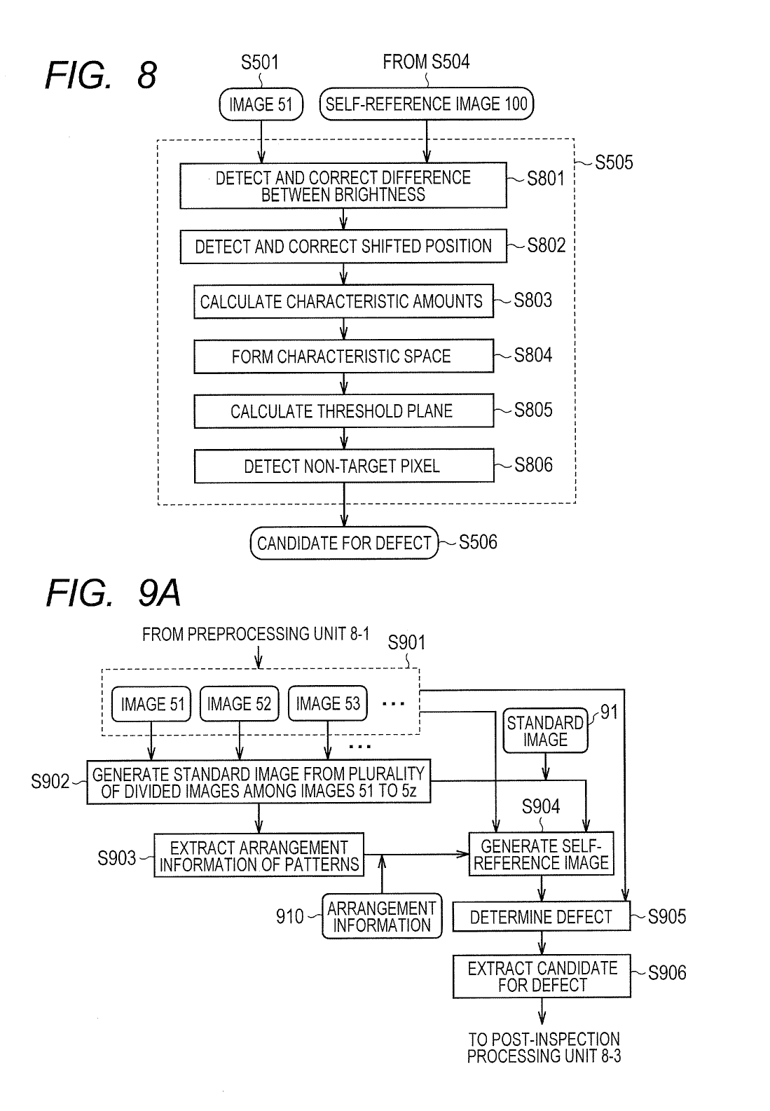

FIG. 8 illustrates the flow of step S505 of determining a defect on the basis of the image to be inspected 51 and the self-reference image 100 by means of the defect determining unit 8-23. As described above, the semiconductor wafer 5 has the same patterns regularly arranged. The image 51 that is input in step S501 originally needs to be the same as the self-reference image 100 generated in step S504. However, since a multi-layer film is formed on the semiconductor wafer 5 and the thickness of the multi-layer film is different between the chips on the semiconductor wafer 5, there are differences between brightness of images. It is, therefore when patches are extracted from chips locating adjacent each other, highly likely that there is a large difference between the brightness of the image 51 input in step S501 and the brightness of the self-reference image 100 generated in step S504. In addition, there is a possibility that the positions of patterns are shifted due to a slightly shifted position (sampling error) of an image acquired during the movement of the stage.

Thus, the defect determining unit 8-23 first corrects the brightness and the positions. The defect determining unit 8-23 detects the difference between the brightness of the image 51 input in step S501 and the brightness of the self-reference image 100 generated in step S504 and corrects the brightness (S801). The defect determining unit 8-23 may correct the brightness of an arbitrary unit, such as the brightness of the whole images, the brightness of the patches, or the brightness of the patches extracted from the image 52 of the adjacent chip and arranged. An example of detecting a difference in brightness between the inputted image and the generated self-reference image and correcting the detected difference by using a least squares approximation is described below.

It is assumed that there is a linear relationship (indicated in Formula 6) between pixels f(x, y) and g(x, y) that are included in the images and correspond to each other. Symbols a and b are calculated so that a value of Formula 7 is minimized and are treated as correction coefficients gain and offset. Then, the brightness data of all pixel values f(x, y) of the image 51, which are the targets of the brightness correction, is input in step S501 and corrected according to Formula 8.

[Formula 6]

g(x, y)=a+b·f(x, y) (Formula 6)

[Formula 7]

Σ{g(x, y)−(a+b·η(x, y))² (Formula 7)

[Formula 8]

L(f(x, y))=gain·f(x, y)+offset (Formula 8)

Next, a shifted amount between the positions of patches within the images is detected and corrected (S802). In this case, the detection and the correction may be performed on all the patches or only the patches extracted from the image 52 of the adjacent chip and arranged. The following methods are generally performed to detect and correct the shifted amount of the positions. In one of the methods, the shifted amount that causes the sum of squares of differences between luminance of the images to be minimized is calculated by shifting one of the images. In another method, the shifted amount that causes a normalized correlation coefficient to be maximized is calculated.

Next, characteristic amounts of target pixels of the image 51 subjected to the brightness correction and the position correction are calculated on the basis of pixels that are included in the self-reference image 100 and correspond to the target pixels (S803). All or some of the characteristic amounts of the target pixels are selected so that a characteristic space is formed (S804). It is sufficient if the characteristic amounts represent characteristics of the pixels. Examples of the characteristic amounts are (a) the contrast (Formula 9), (b) a difference between gray values (Formula 10), (c) a brightness dispersion value of a neighborhood pixel (Formula 11), (d) a correlation coefficient, (e) an increase or decrease in the brightness compared with a neighborhood pixel, and (f) a quadratic differential value.

When the brightness of each point of the detected image is represented by f(x, y) and the brightness of each point of the self-reference image corresponding to the detected image is represented by g(x, y), the examples of the characteristic amounts are calculated from the images (51 and 100) according to the following formulas.

[Formula 9]

The contrast; max{f(x, y), f(x+1, y), f(x, y+1), f(x+1, y+1)}−min{f(x, y), f(x+1, y), f(x, y+1), f(x+1, y+1) (Formula 9)

[Formula 10]

The difference between gray values; f(x, y)−g(x, y) (Formula 10)

[Formula 11]

The dispersion; [Σ{f(x+i, y+j)²}−{Σf(x+i, y+j)}²/M]/(M−1) (Formula 11)

i, j=−1, 0, 1 M=9

In addition, the brightness of each of the images is included in the characteristic amounts. One or more of the characteristic amounts is or are selected from the characteristic amounts. Then, each pixels in each of the images are plotted in a space by the feature amount of the pixels, said space having axes corresponding to the selected feature amounts. Then, a threshold plane that surrounds a distribution estimated as normal is set (S805). A pixel that is located outside the threshold plane or has a characteristically out of range value is detected (S806) and output as a defect candidate (S506). In order to estimate the normal range, a threshold may be set for each of the characteristic amounts selected by the user. The probability that the target pixels are not defect pixels may be calculated and the normal range may be identified when it is assumed that a characteristic distribution of normal pixels is formed in accordance with a normal distribution.

In the latter method, when a number d of characteristic amounts of a number n of normal pixels are represented by x1, x2, . . . , xn, an identification function φ that is used to detect a pixel with a characteristic amount x as a defect candidate is given by Formulas 12 and 13.

$$Probability density function of x \\ p ( x ) = \frac{1}{{( 2 π )}^{\frac{δ}{2}} \sqrt{\vert \sum \vert}} exp ( - \frac{1}{2} {( x - μ )}^{′} ) {\sum }^{- 1} ( x - μ ) \qquad [ Formula 12 ]$$

where μ is the average of all pixels,

$$μ = \frac{1}{n} {\sum }_{i = 1}^{n} {x}_{1}$$

Σ is a covariance,

Σ=Σᵢ₌₁ⁿ(xᵢ−μ)(xᵢ−μ)′ [Formula 12]

[Formula 13]

The discriminant function φ(x)=1 (if p(x)≧th, then, the pixel is a non-defect) φ(x)=0 (if p(x)<th, then, the pixel is a defect) (Formula 13)

In this case, the characteristic space may be formed using all the pixels of the image 51 and self-reference image 100. In addition, a characteristic space may be formed for each of the patches. Furthermore, a characteristic space may be formed for each of all patches arranged on the basis of similar patterns within the image 51 and for each of all the patches extracted from the image 52 of the adjacent chip and arranged. The example of the process of the defect candidate detector 8-2 has been described.

The post-inspection processing unit 8-3 excludes noise and a nuisance defect from the defect candidate detected by the defect candidate detector 8-2, classifies a remaining defect on the basis of the type of the defect, and estimates the dimensions of the defect.

Next, the partial image 52 that is acquired by imaging the adjacent chip 2 is input (S502). A self-reference image is generated from the partial image 52 using the pattern arrangement information acquired from the image 51 of the first die (S504). The generated self-reference image and the partial image 52 are compared with each other to perform a defect determination (S505), then, a defect candidate is extracted (S506). After that, the processes of steps S504 to S506 are sequentially and repetitively performed on partial images that are acquired by the optical system 1 using the pattern arrangement information acquired from the image 51 of the first die, and whereby a defect inspection can be performed on each of the chips formed on the semiconductor wafer 5.

As described above, in the present embodiment, the pattern arrangement information is obtained from the image to be inspected, the self-reference image is generated from the image to be inspected and compared with the image to be inspected, and a defect is detected.

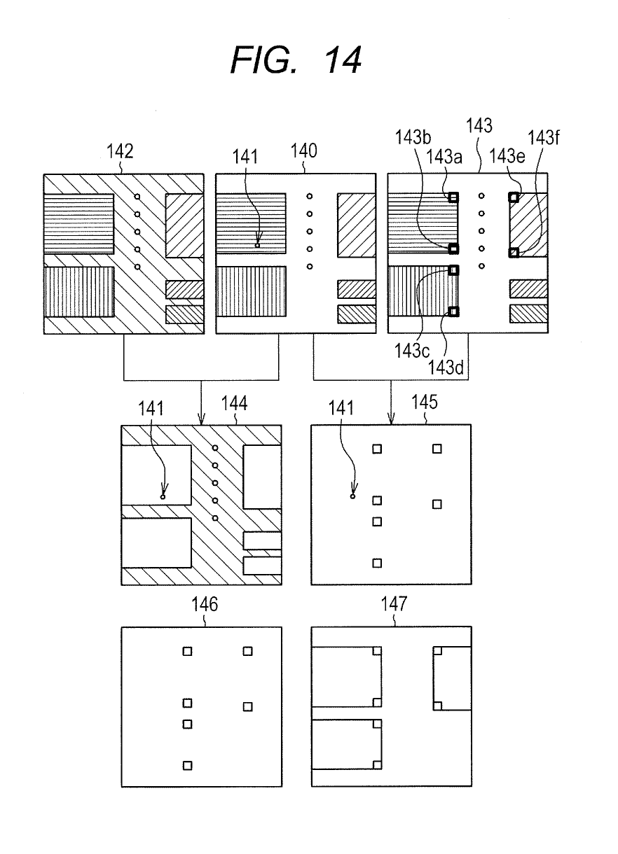

FIG. 14 illustrates an example of the process contents and results, which are displayed on the user interface unit 36 included in the configuration of the device illustrated in FIG. 3. Reference numeral 140 indicates an image that is to be inspected and includes a minute defect 141. Reference numeral 142 indicates a standard image that is generated for the image 140 by statistically processing images that represent parts that are included in a plurality of neighborhood chips and whose positions correspond to each other.

It is general that the image 140 to be inspected is compared with the standard image 142 and a part that is included in the image 140 and largely different from a corresponding part of the image 142 is detected as a defect. Reference numeral 143 indicates a self-reference image that is generated from the image 140 using arrangement information that indicates patterns and has been extracted from the standard image 142 in the present embodiment. The images 140, 142 and 143 are displayed side by side.

Patches 143a to 143f that are included in the self-reference image 143 are located at corners of pattern regions and there are no similar patches within the image 140. The patches 143a to 143f are extracted from the standard image 142, and the positions of the patches 143a to 143f correspond to the positions of parts included in the image 142. Reference numeral 144 indicates the result of the general comparison of the image to be inspected 140 with the standard image 142. In the image 144, the larger the difference between parts of the images 140 and 142, the higher the brightness of a part corresponding to the parts. Reference numeral 145 indicates the result of the comparison of the image to be inspected 140 with the self-reference image 143.

Irregular brightness occurs in a background pattern region of a defect 141 in the image to be inspected 140 due to a difference between the thicknesses of layers included in the semiconductor wafer, compared with the standard image 142. The irregular brightness noticeably appears in the image 144, and a defect does not become obvious in the image 144. On the other hand, the irregular brightness of the background pattern region can be suppressed by the comparison with the self-reference image. The defect can be obvious in the image 145. In a similar manner to the image 144, differences remain in the image 145 at positions that correspond to the patches 143a to 143f extracted from the standard image and arranged in the self-reference image 143.

An image 146 represents patches that are extracted from the standard image 142 and arranged for the generation of the self-reference image 143. An image 147 represents a threshold that is calculated for each of the patches of the self-reference image 143 on the basis of whether the patch is extracted from the image 140 (to be inspected) or the standard image 142. In the image 147, the larger the threshold, the brighter a part that corresponds to the threshold.

In the present embodiment, all or some of the images are displayed side by side. The user can confirm whether a defect has been detected by a comparison of similar patterns within the image to be inspected or has been detected by a comparison of a pattern within the image to be inspected with a pattern that is included in a neighborhood chip and whose position corresponds to the pattern within the image to be inspected. In addition, the user can confirm a threshold value used for the detection.

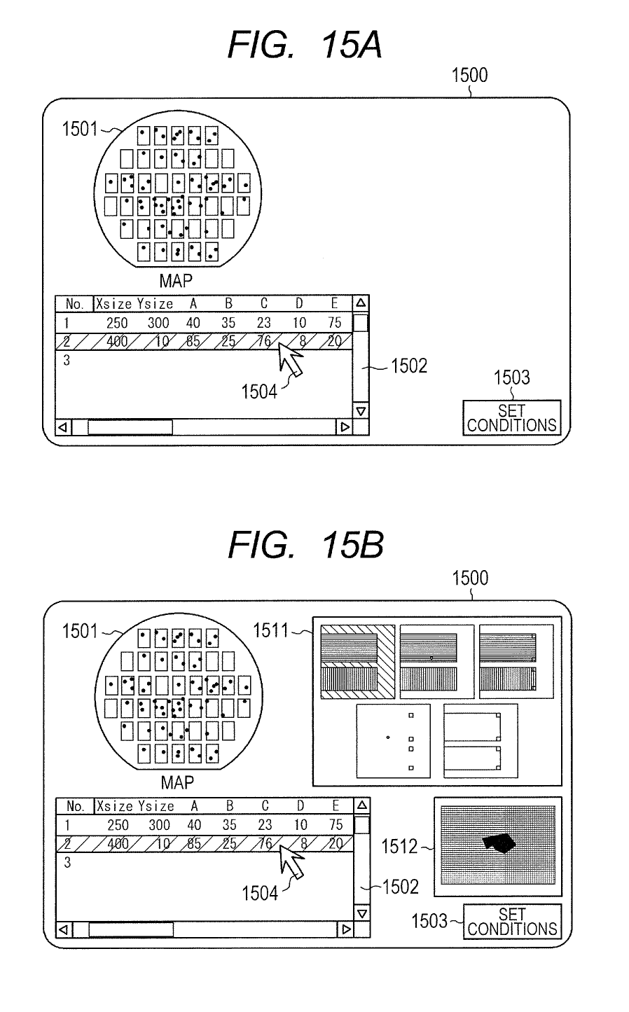

Reference numeral 1500 illustrated in FIG. 15A indicates an example of a process result display screen, which is displayed on the user interface unit (GUI unit) and on which the aforementioned process results are displayed. Reference numeral 1501 indicates a defect map that represents the positions of defects on the semiconductor wafer to be inspected. Black points indicate the positions of the detected defects. Reference numeral 1502 indicates a defect list that represents characteristics of the detected defects. The characteristics of each of the defects are the coordinates of the defect on the wafer, the luminance value of the defect, the area of the defect, and the like. The characteristics can be sorted and displayed in the defect list.

Reference numeral 1503 indicates a condition setting button. When the user wants to change conditions (optical conditions, image processing conditions and the like) and inspect the wafer, the condition setting button is used to change the conditions. When the condition setting button 1503 is pressed, an input button for inputting image processing parameters is displayed so that the user can change the parameters and the conditions. In addition, when the user wants to analyze the type of each of the defects, the images, and details such as information indicating how the defect has been detected, a black point of the defect on the defect map 1501 is selected or the defect is selected from the defect list 1502 (or a defect indicated by No. 2 of the defect list is specified using a pointer (1504) through an operation using a mouse in the case illustrated in FIG. 14b). Then, details of the defect are displayed.

Reference numeral 1510 illustrated in FIG. 15B indicates an example of another display screen on which detailed information of specific defects is displayed as well as the defect map 1501 and the defect list 1502 that are explained above with reference to FIG. 15A. All or some of images of process contents and results (illustrated in FIG. 14) of the selected defects are displayed. As an example of the images, images are displayed in a region indicated by reference numeral 1511 of FIG. 15B. In addition, an observation image (such as an electron beam image or a specularly reflected image acquired by bright-field illumination) that represents a specific defect and is viewed using another detection system can be displayed as indicated by reference numeral 1512.

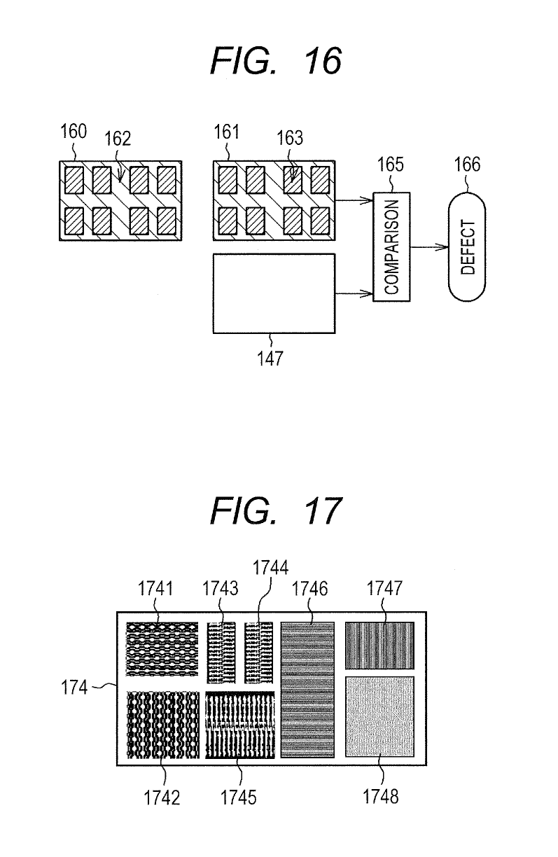

FIG. 16 illustrates the flow of a general process of determining a defect on a semiconductor wafer. The semiconductor wafer has chips (160, 161) regularly arranged in the same manner. Differences between images acquired using the optical system explained with reference to FIG. 3 are calculated. The differences are compared with the separately set threshold image 147 explained with reference to FIG. 14 (165), and a large difference is detected as a defect (166). The chips are each made up of memory mats 163 (small rectangles included in the chips 160 and 161) and a peripheral circuit 162 (region indicated by diagonal lines and included in the chips 160 and 161) in general. The memory mats 163 each have minute periodic patterns, while the peripheral circuits 162 each have a random pattern. It is general that a defect is detected by comparing each of pixels included in each of the memory mats 163 with a pixel separated by one or several intervals from the interested pixel (cell comparison) and that a defect is detected by comparing each of pixels included in each of the peripheral circuits 162 with a pixel that is included in a neighborhood chip and whose position corresponds to the interested pixel (chip comparison or die comparison).

Traditionally, in order to achieve this inspection, it has been necessary that a user should enter definitions (such as start coordinates and end coordinates of each of the memory mats included in the chips, the sizes of the memory mats, intervals between the memory mats, intervals between minute patterns included in the memory mats) of regions of the memory mats or information that indicates the configurations of the chips.

Reference numeral 174 illustrated in FIG. 17 indicates an example of a chip that includes a plurality of memory mats 1741 to 1748. In the example illustrated in FIG. 17, the eight memory mats exist, while the areas of the memory mats, intervals of patterns arranged in the memory mats, and directions (longitudinal directions (of the chips) in which the patterns are arranged at the intervals or lateral directions (of the chips) in which the patterns are arranged at the intervals) in which the patterns are arranged, are different depending on the memory mats. For the chips, it has been necessary that the user should individually define the memory mats 1741 to 1748. In the present embodiment, on the other hand, a comparison (cell comparison) of parts within a chip and a comparison (chip comparison or die comparison) of parts between the chips are automatically switched regardless of whether a memory mat or a non-memory mat is inspected, while information of intervals between repetitive patterns and information of a direction in which the patterns are arranged at the intervals are not required in advance. The optimal sensitivity is automatically set for each of the comparisons, and a defect can be detected.

Even when there is a difference between the brightness of chips (to be compared) due to a slight difference in the thickness of a thin film formed on the patterns after a planarization process such as chemical mechanical polishing (CMP), or a short wavelength of illumination light, it is not necessary to enter layout information on complex chips. Thus, a comparison of the chips is simplest, and a minute defect (for example, a defect of 100 nm or less), which is located in a region in which there is a large difference between the thicknesses of patterns, can be detected with a high sensitivity.

In an inspection of a low-k film such as an inorganic insulating film (such as SiO₂, SiOF, BSG, SiOB, a porous silica film) or an organic insulating film (such as an SiO₂ film containing a methyl group, MSQ, a polyimide-based film, a parylene film, a Teflon (registered trademark) film or an amorphous carbon film), even when a difference between brightness locally exists due to a variation in a refraction index distribution in the film, a minute defect can be detected according to the present invention.

### Second Embodiment

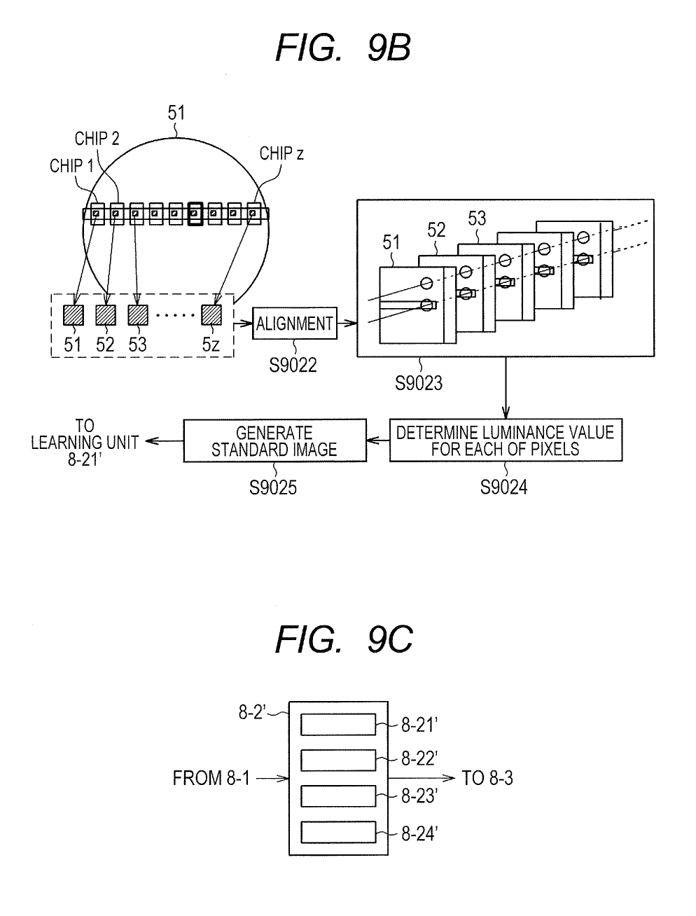

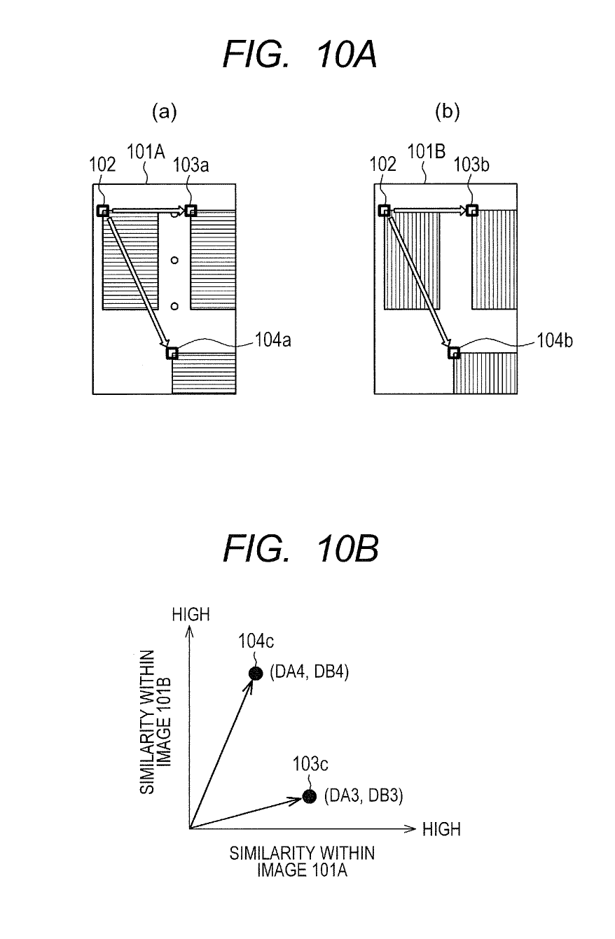

A second embodiment of the present invention is described with FIGS. 9A to 9C and 10. A configuration of a device according to the second embodiment is the same as the configuration illustrated in FIGS. 2, 3A and 3B described in the first embodiment except for the defect candidate detector 8-2, and a description thereof is omitted. The second embodiment is different from the first embodiment in that the part (described with reference to FIGS. 5A to 7 in the first embodiment) of extracting the arrangement information of the patterns and generating the self-reference image. In the first embodiment, the arrangement information of the patterns is obtained from the image of the first die, and the self-reference image is generated from the image to be inspected using the information of the positions of the patterns. The present embodiment describes a method for obtaining arrangement information of patterns from images of a plurality of dies, with reference to FIGS. 9A to 9C and 10.

FIG. 9A illustrates an outline of another process of inputting the divided images 51, 52, . . . , 5z of the regions corresponding to the chip 1, chip 2, chip 3, . . . , chip z repetitively formed on the semiconductor wafer 5 (illustrated in FIG. 9B) to the processor A (refer to FIG. 4A) and detecting a defect candidate from the images 51, 52, . . . , 5z. A defect candidate detector 8-2′ according to the present embodiment includes a learning unit 8-21′, a self-reference image generator 8-22′, a defect determining unit 8-23′ and a standard image generator 8-24′, as illustrated in FIG. 9C.

First, images that are acquired from the optical system 1 by imaging the semiconductor wafer 5 are preprocessed by the preprocessing unit 8-1. After that, the images are input to the same processor included in the defect candidate detector 8-2′ (S901), and a standard image is generated from a plurality of images among the divided images 51, 52, . . . , 5z of parts that are included in the plurality of chips and whose positions correspond to each other (S902).

As an example of a method for generating the standard image, as illustrated in FIG. 9B, position shifts among the plurality of images are corrected (S9021), the images are aligned (S9022), pixel values (luminance values) of parts that are included in the plurality of images and whose coordinates correspond to each other are collected from all pixels (S9023), and a luminance value of each of the pixels is statistically determined as indicated by Formula 14 (S9024). Then, the standard image from which an influence of a defect is excluded is generated (S9025).

S(x, y)=Median {f1(x, y), f2(x, y), f3(x, y), f4(x, y), f5(x, y), . . . } (Formula 14)

Median: a function that outputs a median of the collected luminance values
S(x, y): a luminance value of the standard image
fn(x, y): a luminance value of a divided image 5n after the correction of the positions of the aligned images

As the statistical process, the average value of the collected pixel values may be the luminance value of the standard image.

The images that are used to generate the standard image may include a divided image (up to all the chips formed on the semiconductor wafer 5) that represents a part that is included in a chip arranged in another row and located at a corresponding position.

s(x, y)=Σ{fn(x, y)}/N, N: the number of the divided images used for the statistical process (Formula 15)

Then, arrangement information 910 of patterns is extracted from the standard image (from which the influence of the defect has been excluded) by the learning unit 8-21′ in the same manner as step S503 described with reference to FIG. 5B in the first embodiment (S903). Then, a self-reference image is generated on the basis of the arrangement information 910 for each of the images 51, 52, . . . , 5z from the interested image in the same manner as step S504 explained with reference to FIG. 5B (S904). When a certain pattern (patch) to which a similar pattern (patch) does not exist, a pattern that is included in an adjacent chip and whose coordinates correspond to the coordinates of the certain pattern may be arranged in the self-reference image. In addition, as illustrated in FIG. 9A, the self-reference image may be generated in step S904 (of generating a self-reference image) using the standard image 91 generated in step S902. Next, a defect determination process is performed to compare the self-reference image generated in step S904 with the images 51, 52, 53, . . . , 5z input from the preprocessing unit 8-1 in step S901 (S905), and a defect candidate is extracted (S906). The result of the extraction is transmitted to the post-inspection processing unit 8-3, and the same process as explained in the first embodiment is performed.

As described above, in the present embodiment, the arrangement information 910 of the patterns is extracted from the standard image generated using the images that have been acquired under one optical condition and represent the plurality of regions (S903), the self-reference image is generated (S904), the comparison is performed, the defect is determined in step S905, and the defect candidate is detected in step S906. The arrangement information of the patterns may be extracted from images acquired under different combinations of optical conditions and detection conditions.

FIG. 10A illustrates an example in which arrangement information of patterns is extracted from images 101A and 101B of specific parts located on the wafer in step S903, the images 101A and 101B are acquired under different combinations A and B of optical conditions and detection conditions. In the image 101A acquired under the combination A, a patch that has the highest similarity with a patch 102 is indicated by 103a, and a patch that has the second highest similarity with the patch 102 is indicated by 104a. In the image 101B acquired under the combination B and representing the same region, a patch that has the highest similarity with the corresponding patch 102 is indicated by 104b, and a patch that has the second highest similarity with the patch 102 is indicated by 103b. Similarities that are calculated from each of the images 101A and 101B are integrated, and whereby a similar patch is determined.

As an example of a process of determining the similar patch after the integration, a similarity between patches, which is calculated from the image 101A, is plotted along an abscissa, and a similarity between patches, which is calculated from the image 101B, is plotted along an ordinate, as illustrated in FIG. 10B. The target patches are plotted on the basis of the similarities calculated from both images. A plotted point 103c is a point plotted on the basis of the similarity DA3 between the patches 102 and 103a and the similarity DB3 between the patches 102 and 103b. A point 104c is a point plotted on the basis of the similarity DA4 between the patches 102 and 104a and the similarity DB4 between the patches 102 and 104b. The point 104c that is farther from the origin is treated as a patch having the maximum similarity among the two points. Namely, patches that have the highest similarity with the patch 102 are the patches 104a and 104b. In this manner, similarities that are calculated from a plurality of images that can be differently viewed are integrated, a patch that has the highest similarity is determined, and whereby the accuracy of searching similar patterns in step S903 can be improved.

The process of comparing the image 51 to be inspected with the generated self-reference image and extracting a defect candidate is the same as the process explained with reference to FIG. 8 in the first embodiment. In addition, results of the inspection are the same as the results that are explained with reference to FIG. 14 in the first embodiment.

### Third Embodiment

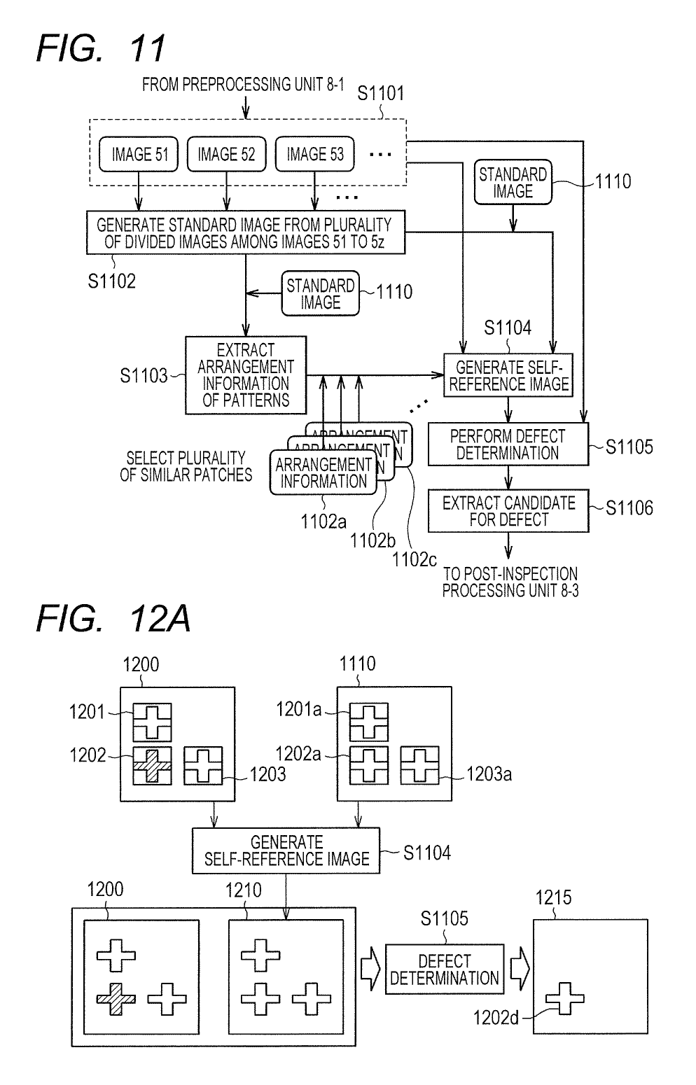

A third embodiment of the present invention is described with reference to FIGS. 11 to 13. A configuration of a device according to the third embodiment is the same as the configuration illustrated in FIGS. 2, 3A and 3B described in the first embodiment except for the defect candidate detector 8-2, and a description thereof is omitted. In the example of extracting the information (explained with reference to FIGS. 10A and 10B) of the positions of the patterns as described in the second embodiment, the single pattern that has the highest similarity is determined from the candidates of the two similar patterns. But in actual, a plurality of similar patterns are existing in a single image in many cases. The present embodiment describes a method for determining a defect with higher reliability by using a plurality of similar patterns.

FIG. 11 illustrates the flow of a process. The divided images 51, 52, 53, . . . , 5z that represent the regions that are included in the chip 1, chip 2, chip 3, . . . , chip z and correspond to each other are acquired (S1101). A standard image 1110 is generated from two or more of the acquired divided images (S1102).

A method for generating the standard image 1110 is the same as the method described in the first and second embodiments. Arrangement information of patterns is extracted from the standard image 1110 by the learning unit 8-21′ (S1103). In this case, one patch that has the highest similarity is not extracted, information of a patch with the highest similarity, a patch with the second highest similarity, a patch with the third highest similarity, . . . , and pattern information are extracted, and the coordinates of the patches are held as arrangement information (1102a, 1102b, 1102, . . . ). Then, a self-reference image is generated for each of the images 51, 52, . . . , 5z (to be inspected) from the image on the basis of the arrangement information (1102a, 1102b, 1102c, . . . ) (S1104). Then, the process (illustrated in FIG. 8) of detecting an out of range pixel is performed for each of the generated self-reference images in step S1105 of performing a defect determination. Out of range pixels that are detected from all the self-reference images are integrated, and a defect candidate is detected (S1106).

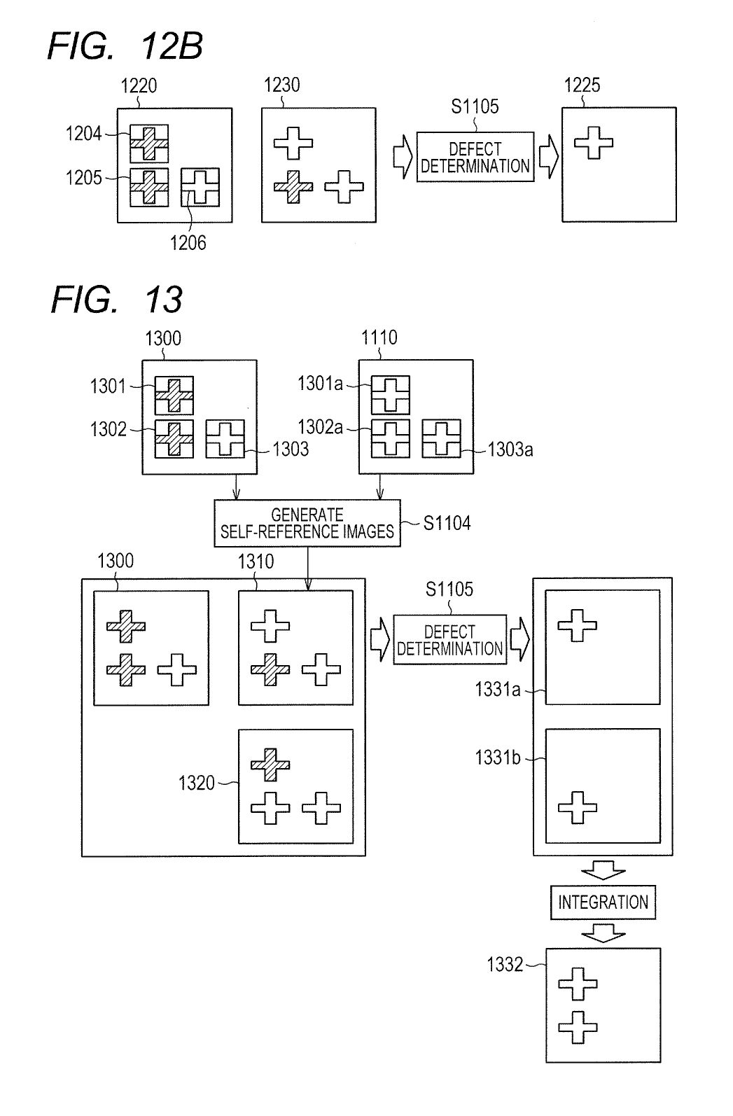

As an example of the integration, an evaluation value (for example, a distance from a normal distribution estimated on a characteristic space) that is calculated from each of the pixels and used to evaluate whether or not the pixel is an out of range pixel is calculated from each of the self-reference images. Then the integration is performed by calculating a logical product (the minimum evaluation value among the pixels) of the evaluation values or a logical sum (the maximum evaluation value among the pixels) of the evaluation values. Examples of a specific effect of the integration are illustrated in FIGS. 12A, 12B and 13.

Reference numeral 1200 illustrated in FIG. 12A indicates an image of a chip to be inspected while reference numeral 1100 indicates the standard image. A pattern (cross pattern indicated by horizontal stripes) that exists in a patch 1202 among patches 1201 to 1203 is a defect. It is assumed that, in step S1103, a patch that is similar to a patch 1201a of the standard image 1110 is extracted as a patch 1203a, a patch that is similar to a patch 1202a of the standard image 1110 is extracted as the patch 1201a, and a patch that is similar to the patch 1203a of the standard image 1110 is extracted as the patch 1201a. A self-reference image 1210 is generated for the image 1200 from this arrangement information in step S1104. Then, the image 1200 and the self-reference image 1210 are compared with each other in step S1105, and an image 1215 that represents a difference between the image 1200 and the self-reference image 1210 is generated. Then, a defect 1202d is detected (S1106).

On the other hand, when defects occur in patches 1204 and 1205 among patches 1204 to 1206 included in an image 1220 (illustrated in FIG. 12B) to be inspected, a self-reference image 1230 is generated for the image 1220 from the aforementioned arrangement information in step S1104. The defect that occurs in the patch 1205 cannot be detected from an image 1225 that represents a difference between the image 1220 generated in step S1105 of performing the defect determination and the self-reference image 1230. In addition, when the patches 1204 and 1205 are similar to each other, the two defects cannot be detected.

FIG. 13 illustrates an example in which large defects that exist across a plurality of similar patterns can be detected using a plurality of pattern arrangement information pieces. The defects occur in patches 1301 and 1302 among three patches 1301 to 1303 included in an image 1300 to be inspected. In step S1104 of generating a self-reference image, the self-reference image generator 8-22′ generates an image 1310 for the image 1300 from the aforementioned arrangement information obtained in step S1103. In addition, in step S1103, the learning unit 8-21′ obtains arrangement information of patterns on the basis of a patch with the second highest similarity. In step S1104 of generating a self-reference image, the self-reference image generator 8-22′ also generates a self-reference image 1320 from the pattern arrangement information obtained on the basis of the patch with the second highest similarity.

In this case, the self-reference image is generated from the second pattern arrangement information obtained in the case in which a patch that is the second most similar patch to the patch 1301i a is a patch 1302a and a patch that is the second most similar patch to the patch 1302a is a patch 1303a. Then, in step S1105 of performing the defect determination, the defect determining unit 8-23′ compares the image 1300 with the two self-reference images 1310 and 1320. A difference image 1331a and a difference image 1331b that are the results of the comparisons are extracted as defect candidates (S1106).

Then, the defect determining unit 8-23′ integrates the two comparison results (or calculates a logical sum of the two comparison results in this example), and whereby an image 1332 that represents the defects occurring in the patches 1301 and 1302 of the image 1300 to be inspected is extracted. This example describes that the logical sum of the results of the comparisons with the two self-reference images is calculated in order to prevent the large defects from being overlooked. The defects can be detected, with higher reliability, by calculating a logical product of results of comparisons with two or more of self-reference images in order to prevent an erroneous detection, although a process of detecting the defects by calculating the logical product is a little complex.

A process of extracting defect candidates through the comparisons of the image 51 to be inspected with the generated self-reference images is the same as the process explained with reference to FIG. 8. In addition, the inspection results to be output are the same as the results explained with reference to FIG. 14 in the first embodiment.

The embodiment of the present invention describes that the images that represent the semiconductor wafer and are to be compared and inspected are used in the dark-field inspection device. Images to be compared through a pattern inspection using an electron beam may be applied. In addition, a pattern inspection device that performs bright-field illumination may be applied.

An object to be inspected is not limited to the semiconductor wafer. For example, a TFT substrate, a photomask, a printed board and the like may be applied as long as defect detection is performed through a comparison of images.

### INDUSTRIAL APPLICABILITY

The present invention can be applied to a defect inspection device and method, which enable a minute pattern defect, a foreign material and the like to be detected from an image (detected image) of an object (to be inspected) such as a semiconductor wafer, a TFT or a photomask.

### DESCRIPTION OF REFERENCE CHARACTERS

1 . . . Optical system 2 . . . Memory 3 . . . Image processing unit 4a, 4b . . . Illuminating unit 5 . . . Semiconductor wafer 7a, 7b . . . Detector 8-2 . . . Defect candidate detector 8-3 . . . Post-inspection processing unit 31, 32 . . . Sensor 9 . . . Whole controller 36 . . . User interface unit

1. A defect inspection device that inspects a pattern formed on a sample, comprising:
table means that holds the sample thereon and is capable of continuously moving in at least one direction;
image acquiring means that images the sample held on the table means and acquires an image of the pattern formed on the sample;
pattern arrangement information extracting means that extracts arrangement information of the pattern from the image of the pattern that has been acquired by the image acquiring means;
reference image generating means that generates a reference image from the arrangement information of the pattern and the image of the pattern, the arrangement information being extracted by the pattern arrangement information extracting means, the image of the pattern being acquired by the image acquiring means; and
defect candidate extracting means that compares the reference image generated by the reference image generating means with the image of the pattern that has been acquired by the image acquiring means thereby extracting a defect candidate of the pattern.

2. The defect inspection device according to claim 1,
wherein the image acquiring means divides the acquired image of the pattern and outputs divided images,
wherein the pattern arrangement information extracting means extracts arrangement information of the pattern from the divided images output from the image acquiring means,
wherein the reference image generating means generates reference images corresponding to the divided images, and
wherein the defect candidate extracting means compares the reference images generated by the reference image generating means and corresponding to the divided images with the divided images output from the image acquiring means thereby extracting a defect candidate of the pattern.

3. The defect inspection device according to claim 1,
wherein the image acquiring means includes an illumination optical system for irradiating the sample with light, and a reflected light detection optical system for detecting light reflected from the sample that is irradiated with the light by the illumination optical system.

4. The defect inspection device according to claim 1, further comprising
defect classifying/dimension estimating means that excludes a nuisance defect and noise from the defect candidate extracted by the defect candidate extracting means, classifies a remaining defect on the basis of the type of the remaining defect, and estimates a dimension of the remaining defect.

5. A defect inspection device that inspects patterns that have been repetitively formed on a sample and originally need to have the same shape, comprising:
table means that holds the sample thereon and is capable of continuously moving in at least one direction;
image acquiring means that images the sample held on the table means and sequentially acquires images of the patterns that have been repetitively formed on the sample and originally need to have the same shape;
standard image generating means that generates a standard image from the images of the patterns that have been sequentially acquired by the image acquiring means that have been repetitively formed and originally need to have the same shape;
pattern arrangement information extracting means that extracts, from the standard image generated by the standard image generating means, arrangement information of the patterns that originally need to have the same shape;
reference image generating means that generates a reference image using the arrangement information of the patterns extracted by the pattern arrangement information extracting means, and an image of a pattern to be inspected among the images of the patterns sequentially acquired by the image acquiring means that originally need to have the same shape, or the standard image generated by the standard image generating means; and
defect candidate extracting means that compares the reference image generated by the reference image generating means with the image of the pattern to be inspected among the images of the patterns sequentially acquired by the image acquiring means that originally need to have the same shape thereby extracting a defect candidate of the pattern to be inspected.

6. The defect inspection device according to claim 5,
wherein the image acquiring means divides the images of the patterns that have been repetitively formed and sequentially acquired and originally need to have the same shape, and outputs the divided images,
wherein the standard image generating means generates divided standard images that correspond to the divided images output from the image acquiring means and obtained from the images of the patterns that have been repetitively formed and originally need to have the same shape,
wherein the pattern arrangement information extracting means extracts arrangement information of the patterns from the divided standard images generated by the standard image generating means,
wherein the reference image generating means generates reference images corresponding to the divided images using the arrangement information of the patterns extracted from the divided standard images by the pattern arrangement information extracting means, and the divided images output from the image acquiring means, or the divided standard images generated by the standard image generating means, and
wherein the defect candidate extracting means compares the reference images generated by the reference image generating means and corresponding to the divided images with the divided images output from the image acquiring means thereby extracting a defect candidate of the pattern.

7. The defect inspection device according to claim 5,
wherein the image acquiring means includes an illumination optical system for irradiating the sample with light, and a reflected light detection optical system for detecting light that is reflected from the sample irradiated with the light by the illumination optical system.

8. The defect inspection device according to claim 5, further comprising
defect classifying/dimension estimating means that excludes a nuisance defect and noise from the defect candidate extracted by the defect candidate extracting means, classifies a remaining defect on the basis of the type of the remaining defect, and estimates a dimension of the remaining defect.

9. A defect inspection method for inspecting a pattern formed on a sample, comprising the steps of:
imaging the sample while continuously moving the sample in a direction, and acquiring images of the patterns formed on the sample;
extracting arrangement information of the pattern from the acquired images of the patterns;
generating a reference image from an image to be inspected among the acquired images of the patterns using the extracted arrangement information of the pattern; and
comparing the generated reference image with the image to be inspected thereby extracting a defect candidate of the pattern.

10. The defect inspection method according to claim 9,
wherein in the step of extracting the arrangement information of the pattern, arrangement information of the pattern is extracted from each of images obtained by dividing the acquired images of the patterns,
wherein in the step of generating the reference image, reference images that correspond to the divided images are generated using the divided images and the arrangement information of the pattern extracted from each of the divided images, and
wherein in the step of extracting the defect candidate of the pattern, the defect candidate of the pattern is extracted by comparing the generated reference images corresponding to the divided images with the divided images.

11. The defect inspection method according to claim 9,
Wherein in the step of imaging the sample, the images of the patterns are acquired by irradiating the sample with the light and detecting light reflected from the sample irradiated with the light.

12. The defect inspection method according to claim 9,
wherein the step of extracting the defect candidate of the pattern includes the step of excluding a nuisance defect and noise from the extracted candidate, classifying a remaining defect on the basis of the type of the remaining defect, and estimating a dimension of the remaining defect.

13. A defect inspection method for inspecting patterns that have been repetitively formed on a sample and originally need to have the same shape, comprising the steps of:
imaging the sample while continuously moving the sample in a direction, and sequentially acquiring images of the patterns that have been repetitively formed on the sample and originally need to have the same shape;
generating a standard image from a plurality of images of the patterns that have been sequentially acquired in the step of imaging, said patterns are repetitively formed on the sample and originally need to have the same shape;
extracting, from the generated standard image, arrangement information of the patterns that originally need to have the same shape;
generating a reference image using the extracted arrangement information of the patterns, and an image of a pattern to be inspected among the images of the patterns that have been sequentially acquired that originally need to have the same shape, or the generated standard image; and
comparing the generated reference image with the image of the pattern to be inspected thereby extracting a defect candidate of the pattern to be inspected.

14. The defect inspection method according to claim 13,
wherein in the step of generating the standard image, divided standard images that correspond to images obtained by dividing the images of the patterns that have been repetitively formed on the sample and originally need to have the same shape are generated,
wherein in the step of extracting the arrangement information of the patterns, arrangement information of the patterns is extracted from each of the divided and generated standard images,
wherein in the step of generating the reference image, reference images that correspond to the divided images are generated using the arrangement information that has been extracted from each of the divided standard images and the divided images or the divided standard images, and
wherein in the step of extracting the defect candidate of the pattern, the generated reference images that correspond to the divided images are compared with the divided images, and the defect candidate of the pattern is extracted.

15. The defect inspection method according to claim 13,
Wherein in the step of imaging the sample, the images of the patterns are acquired by irradiating the sample with the light and detecting light reflected from the sample irradiated with the light.

16. The defect inspection method according to claim 13,
wherein the step of extracting the defect candidate of the pattern includes the steps of excluding a nuisance defect and noise from the defect candidate, classifying a remaining defect on the basis of the type of the remaining defect, and estimating a dimension of the remaining defect.
